(19) United States
(12) Patent Application Publication
(10) Pub. No.: US 2025/0308508 A1
(43) Pub. Date: Oct. 2, 2025

(54) DATA TRANSMISSION METHOD AND APPARATUS THEREOF

(71) Applicant: MEDIATEK INC., Hsinchu City (TW)

(72) Inventors: Yu-Ching TUNG, Hsinchu City (TW); Chien-Yi WANG, Hsinchu City (TW); Hao-Cheng WANG, Hsinchu City (TW); Yung-Liang TSOU, Hsinchu City (TW); Hao-Chen CHOU, Hsinchu City (TW); Cheng-hsien CHANG, Hsinchu City (TW)

(21) Appl. No.: 19/086,261

(22) Filed: Mar. 21, 2025

Related U.S. Application Data
(60) Provisional application No. 63/572,977, filed on Apr. 2, 2024.

(51) Int. Cl. G10L 13/027; G10L 13/033; G10L 25/63

(52) U.S. Cl. CPC G10L 13/027; G10L 13/033; G10L 25/63

(57) ABSTRACT

A data transmission method is provided. The data transmission method may include the following steps. A transmitting apparatus may generate a voice data for a voice call or a video data for a video call. The transmitting apparatus may transform the voice data or the video data into an abstract data according to a first artificial intelligence (AI) model, wherein the abstract data includes information related to the voice data or the video data, and a size of the abstract data is smaller than a size of the voice data or the video data. The transmitting apparatus may transmit the transmitting apparatus, the abstract data to a receiving apparatus. The receiving apparatus may synthesize a synthesized voice data or a synthesized video data from the abstract data according to a second AI model. The receiving apparatus may play the synthesized voice data or the synthesized video data.

### CROSS REFERENCE TO RELATED APPLICATIONS

This application claims the benefit of U.S. Provisional Application No. 63/572,977 filed on Apr. 2, 2024, the entirety of which is incorporated by reference herein.

### BACKGROUND OF THE INVENTION

### Field of the Invention

The invention generally relates to wireless communications technology, and more particularly, it relates to data transmission over a network with low bit rate limit.

### Description of the Related Art

Unless otherwise indicated herein, approaches described in this section are not prior art to the claims listed below and are not admitted as prior art by inclusion in this section.

With the transmission technologies used in a conventional voice call (e.g., a voice over LTE (VoLTE) call, a voice over NR (VoNR) call, or a voice over Wi-Fi (VoWiFi) call), as well as the transmission technologies used in a video call (e.g., video over LTE (ViLTE) call, video over NR (ViNR) call), current codecs may be not sufficient for the voice or video call, when it is performed on a network with a lower bit rate (e.g., NR-NTN network or internet-of-things (IoT)-NTN (IoT-NTN) network) limit.

Therefore, how to perform a voice or video call on a network with a lower bit rate limit is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to data transmission over a network with a low bit rate limit with respect to the transmitting apparatus and the receiving apparatus. It is believed that the issue described above can be avoided or otherwise alleviated by implementing one or more of the proposed schemes described herein.

An embodiment of the invention provides a data transmission method. The data transmission method may be applied to a data transmission system. The data transmission method may include the following steps. The data transmission method may comprise that the transmitting apparatus of the data transmission system generating voice data for a voice call or video data for a video call. The data transmission method may also comprise the transmitting apparatus transforming the voice or video data into abstract data according to a first artificial intelligence (AI) model. The abstract data may comprise information related to the voice or video data, and the size of the abstract data is smaller than the size of the voice or video data. The data transmission method may further comprise that the transmitting apparatus may transmit the abstract data to a receiving apparatus of the data transmission system. The data transmission method may further comprise that the receiving apparatus may synthesize synthesized voice data or synthesized video data from the abstract data according to a second AI model. The data transmission method may further comprise that the receiving apparatus may play the synthesized voice data or the synthesized video data.

In some embodiments, the information of the abstract data may comprise media description, words, phrases, and emotional information in the voice or video data.

In some embodiments, the first AI model may comprise at least one of hidden Markov model (HMM) model and neural network model.

In some embodiments, the second AI model may comprise a text-to-speech (TTS) model.

In some embodiments, the voice print information may be stored in the receiving apparatus. The data transmission method may further comprise that the receiving apparatus may synthesize the synthesized voice data or the synthesized video data according to the abstract data and the voice print information.

An embodiment of the invention provides a data transmission system. The data transmission system may comprise a transmitting apparatus, a network node, and a receiving apparatus. The receiving device may wirelessly communicate with the transmitting device through the network node. The transmitting device may generate voice data for a voice call or video data for a video call, transforming the voice or video data into abstract data according to a first AI model. The abstract data may comprise information related to the voice or video data, and the size of the abstract data is smaller than the size of the voice or video data, and transmits the abstract data to the receiving apparatus. The receiving device may synthesize synthesized voice data or synthesized video data from the abstract data according to the second AI model, and play the synthesized voice data or the synthesized video data.

An embodiment of the invention provides a data transmission method. The data transmission method may be applied to a receiving apparatus. The data transmission method may include the following steps. The data transmission method may comprise that the receiving apparatus may perform a voice call or a video call with a transmitting device. The data transmission method may also comprise that the receiving apparatus may receive abstract data from the transmitting apparatus. The abstract data may comprise information related to the voice data for the voice call or video data for the video call, and the size of the abstract data may be smaller than the size of the voice or video data. The data transmission method may further comprise that the receiving apparatus may synthesize synthesized voice data or synthesized video data from the abstract data according to an AI model. The data transmission method may further comprise that the receiving apparatus may play the synthesized voice data or the synthesized video data.

An embodiment of the invention provides an apparatus. The apparatus may comprise a transceiver and a processor. During operation, the transceiver may wirelessly communicate with a transmitting apparatus through a network node. The processor may be communicatively coupled to the transceiver such that, during operation, the processor performs the following operations. The processor may perform a voice call or a video call with the transmitting device. The processor may receive, via the transceiver, an abstract data from the transmitting apparatus. The abstract data may comprise information related to voice data for the voice call or video data for the video call, and the size of the abstract data may be smaller than the size of the voice or video data. The processor may synthesize synthesized voice data or synthesized video data from the abstract data according to an AI model. The processor may play the synthesized voice data or the synthesized video data.

Other aspects and features of the invention will become apparent to those with ordinary skill in the art upon review of the following descriptions of specific embodiments of the data transmission methods, system and apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a flow chart illustrating a data transmission method according to an embodiment of the invention.

FIG. 5 is a flow chart illustrating a data transmission method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

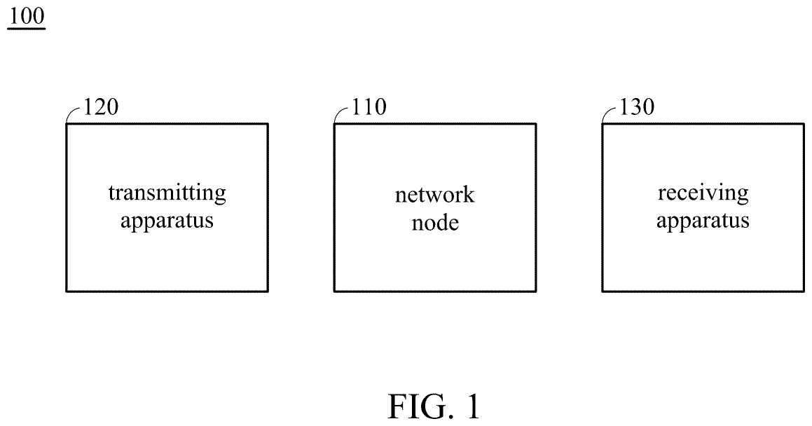

FIG. 1 is a block diagram of a wireless communication system 100 according to an embodiment of the application. As shown in FIG. 1, the wireless communication system 100 may include a network node 110, a transmitting apparatus 120, and a receiving apparatus 130. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point (AP), an access terminal, a Wi-Fi hotpot, but the invention should not be limited thereto. In an embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto. In another embodiment, the communication apparatus 120 may be in wireless communication with a wireless network including a non-terrestrial network (NTN) (e.g., NR-NTN network or internet-to-things (IoT)-NTN (IoT-NTN) network) and a TN via the network node 110. That is, the network node 110 may be a terrestrial network node (e.g., an eNB, a gNB, or a transmission/reception point (TRP)) and/or a non-terrestrial network node (e.g., a satellite). For example, the terrestrial network node and/or the non-terrestrial network node may form an NTN serving cell for wireless communication with the transmitting apparatus 120 and the receiving apparatus 130.

In the embodiments of the invention, the transmitting apparatus 120 may be a user equipment (UE), a non-AP station (STA), a smartphone, Personal Data Assistant (PDA), a pager, laptop computer, a desktop computer, a wireless handset, or any computing device that includes a voice call function or a video call function. In the embodiments of the invention, the receiving apparatus 130 may also be a UE, a non-AP STA, a smartphone, a PDA, pager, a laptop computer, a desktop computer, a wireless handset, or any computing device that includes a voice call function or a video call function.

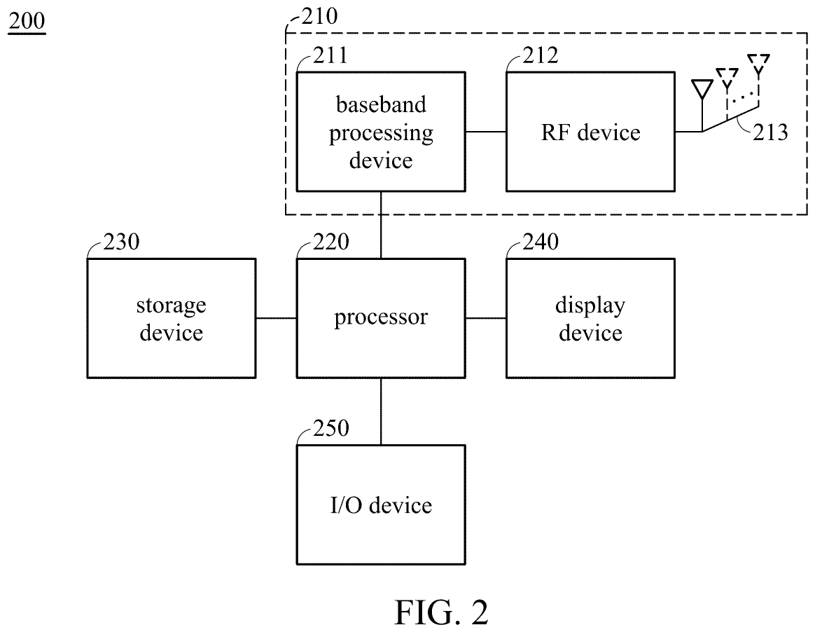

FIG. 2 is a block diagram illustrating a communication apparatus 200 according to an embodiment of the application. The communication apparatus 200 can be applied to the transmitting apparatus 120 and the receiving apparatus 130. As shown in FIG. 2, the communication apparatus 200 may comprise a wireless transceiver 210, a processor 220, a storage device 230, a display device 240, and an Input/Output (I/O) device 250.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, and the I/O device 250 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

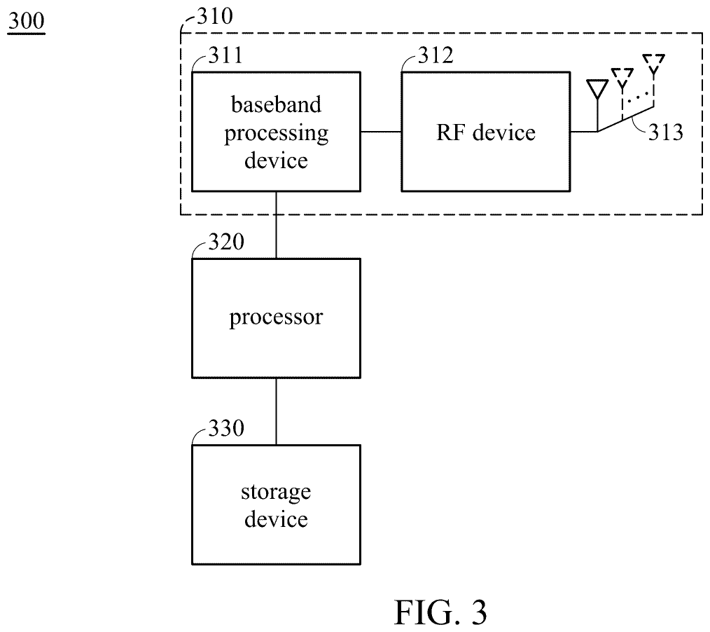

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPU/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, when a transmitting apparatus (or mobile originated (MO) apparatus) (e.g., transmitting device 120) is performing a voice call or video call with a receiving apparatus (or mobile terminate (MT) apparatus) (e.g., receiving apparatus 130) through a network node (e.g., network node 110), the transmitting apparatus may generate voice data for the voice call or video data for the video call. Then, the transmitting apparatus may transform the voice or video data into abstract data according to the first AI model. The abstract data may comprise information related to the voice or video data. In addition, the size of the abstract data may be smaller than the size of the voice or video data. Then, the transmitting apparatus may transmit the abstract data to the receiving apparatus. That is, in the embodiments of the invention, the transmitting apparatus may not directly transmit the voice or video data to the receiving apparatus to reduce the data rate. Specifically, because the size of the abstract data is smaller than the size of the voice or video data, the data rate for transmitting the voice data for the voice call or the video data for the video call can be reduced. Therefore, even if the transmitting apparatus performs a voice call or a video call with the receiving apparatus through a network with a lower bit rate limit (e.g., NR-NTN network or IoT-NTN network), the lower bit rate can be achieved.

According to an embodiment of the invention, the first AI model may comprise at least one of a hidden Markov model (HMM), a neural network model, but the invention should not be limited thereto. The neural network model may comprise deep neural network (DNN) model, recurrent neural network (RNN), and convolutional neural network (CNN), but the invention should not be limited thereto.

According to an embodiment of the invention, the information of the abstract data may comprise the key (or main) point or concept of the voice of the user of the transmitting apparatus. For example, the information of the abstract data may comprise the key (or main) point or concept of the media description (e.g., the contents or text summary in the voice data or video data) related to the voice of the user of the transmitting apparatus. In another example, the information of the abstract data may comprise the key (or main) point or concept of the words (e.g., the key words in the voice data or video data) related to the voice of the user of the transmitting apparatus. In another example, the information of the abstract data may comprise the phrases (e.g., the key phrases in the voice data or video data) related to the voice of the user of the transmitting apparatus. In another example, the information of the abstract data may comprise the key (or main) point or concept of the emotional information (e.g., emotional cues of the voice of the user of the transmitting apparatus or emotion of the intonation of the voice of the user of the transmitting apparatus) in the voice or video data. Specifically, the transmitting apparatus may use the first AI model to analyze the voice or video data which is needed to be transmitted from the transmitting apparatus to the receiving apparatus to extract or obtain the information of the abstract data.

According to another embodiment of the invention, the information of the abstract data may further comprise image information in an event that the abstract data is generated based on the video data. Specifically, in an event that the abstract data is generated based on the video data, the transmitting apparatus may use the first AI model to analyze the image frames in the video data to extract or obtain the image information corresponding to the video data.

After the receiving apparatus receives the abstract data from the transmitting apparatus, the receiving apparatus may synthesize synthesized voice data or synthesized video data from the abstract data according to the second AI model. Then, the receiving apparatus may play the synthesized voice data or the synthesized video data.

According to an embodiment of the invention, the second AI model may comprise a text-to-speech (TTS) model, but the invention should not be limited thereto. Specifically, the receiving apparatus may use the second AI model to synthesize a speech data (i.e., the synthesized voice data or the synthesized video data) according to the abstract data. The speech data may comprise closely mimics human voice, e.g., the tone, pace and emotional expressions of original speaker (i.e., the user of the transmitting apparatus) in the voice or video data. Therefore, when the receiving apparatus plays the synthesized voice data or the synthesized video data, the receiving apparatus may obtain the contents or information of the voice or video data from the transmitting apparatus in the voice or video call.

According to an embodiment of the invention, the voice print information may be pre-stored in the receiving apparatus. The receiving apparatus may synthesize the synthesized voice data or the synthesized video data according to the abstract data and the voice print information. The voice print information may comprise different voice information of different people (e.g., the contact persons of the phone book of the receiving apparatus). According to another embodiment of the invention, the transmitting apparatus may also transmit its voice print information to the receiving apparatus.

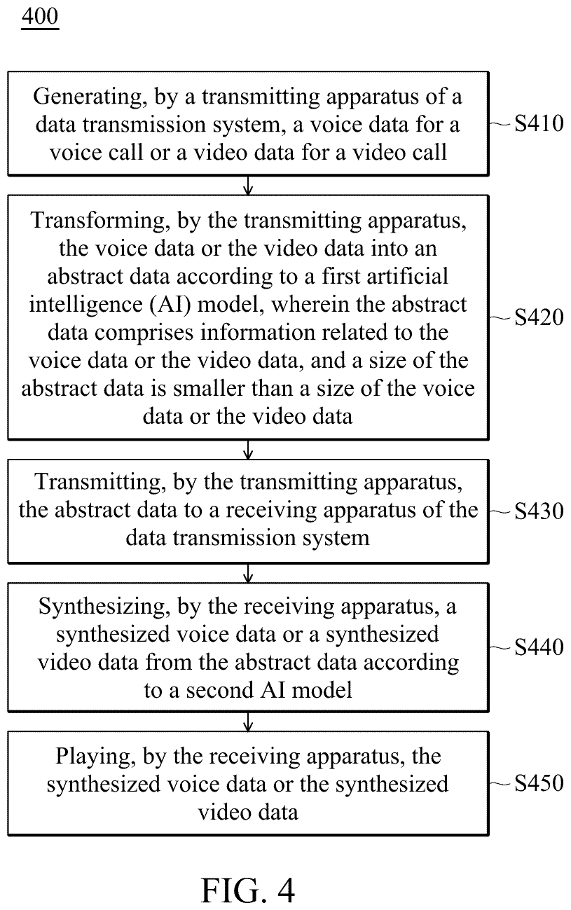

FIG. 4 is a flow chart illustrating a data transmission method 400 according to an embodiment of the invention. The data transmission method can be applied to a data transmission system (e.g., the wireless communication system 100). As shown in FIG. 4, in step S410, a transmitting apparatus of the data transmission system 100 may generate voice data for a voice call or video data for a video call.

In step S420, the transmitting apparatus of the data transmission system 100 may transform the voice or video data into abstract data according to the first AI model. The abstract data may comprise information related to the voice or video data, and the size of the abstract data may be smaller than the size of the voice or video data.

In step S430, the transmitting apparatus of the data transmission system 100 may transmit the abstract data to a receiving apparatus of the data transmission system 100.

In step S440, the receiving apparatus of the data transmission system 100 may synthesize synthesized voice data or synthesized video data from the abstract data according to the second AI model.

In step S450, the receiving apparatus of the data transmission system 100 may play the synthesized voice data or the synthesized video data.

According to an embodiment of the invention, in the data transmission method, the information of the abstract data comprises media description, words, phrases, and emotional information in the voice or video data.

According to an embodiment of the invention, in the data transmission method, the first AI model comprises at least one of an HMM model and a neural network model.

According to an embodiment of the invention, in the data transmission method, the second AI model may comprise a TTS model.

According to an embodiment of the invention, in the data transmission method, the voice print information may be stored in the receiving apparatus of the data transmission system 100. In addition, the receiving apparatus of the data transmission system 100 may synthesize the synthesized voice data or the synthesized video data according to the abstract data and the voice print information.

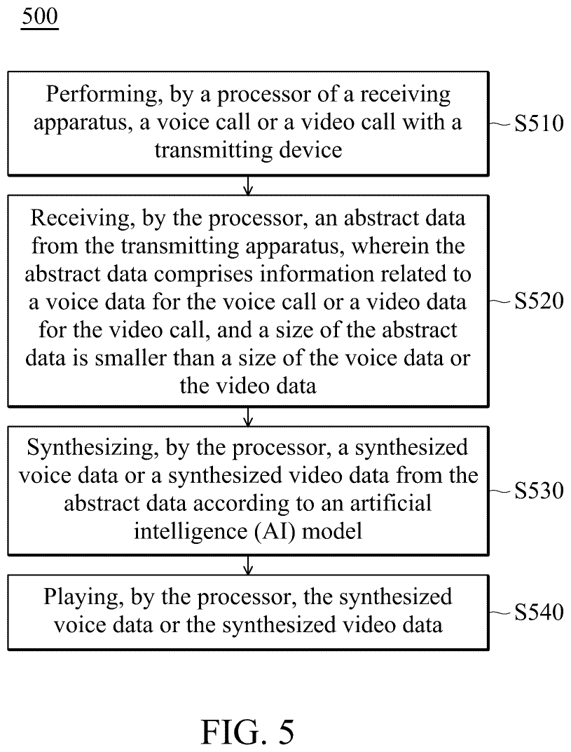

FIG. 5 is a flow chart illustrating a data transmission method 500 according to another embodiment of the invention. The data transmission method can be applied to an apparatus (e.g., the receiving apparatus 130 of the wireless communication system 100). As shown in FIG. 5, in step S510, a processor of the receiving apparatus 130 may perform a voice call or a video call with a transmitting device.

In step S520, the processor of the receiving apparatus 130 may receive via a transceiver of the receiving apparatus 130, an abstract data from the transmitting apparatus. The abstract data may comprise information related to voice data for the voice call or video data for the video call, and the size of the abstract data is smaller than the size of the voice or video data.

In step S530, the processor of the receiving apparatus 130 may synthesize synthesized voice data or synthesized video data from the abstract data according to an AI model.

In step S540, the processor of the receiving apparatus 130 may play the synthesized voice data or the synthesized video data.

According to an embodiment of the invention, in the data transmission method, the information of the abstract data may comprise media description, words, phrases, and emotional information in the voice or video data. In addition, the information of the abstract data may further comprise image information in an event that the abstract data is generated based on the video data.

According to an embodiment of the invention, in the data transmission method, the AI model comprises a TTS model.

According to an embodiment of the invention, in the data transmission method, the voice print information is stored in the receiving apparatus. In addition, the processor of the receiving apparatus 130 may synthesize the synthesized voice data or the synthesized video data according to the abstract data and the voice print information.

According to the data transmission method provided in the embodiments of the invention, the transmitting apparatus can transform the voice or video data into the abstract data according to the AI model previously rather than directly transmitting the voice or video data to the receiving apparatus, and the receiving apparatus can synthesize the synthesized voice data or the synthesized video data according to the abstract data. Therefore, even if the transmitting apparatus performs a voice call or a video call with the receiving apparatus through a network with a lower bit rate limit (e.g., NR-NTN network or IoT-NTN network), the lower bit rate can be achieved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission method, comprising:
generating, by a transmitting apparatus of a data transmission system, a voice data for a voice call or a video data for a video call;
transforming, by the transmitting apparatus, the voice data or the video data into an abstract data according to a first artificial intelligence (AI) model, wherein the abstract data comprises information related to the voice data or the video data, and a size of the abstract data is smaller than a size of the voice data or the video data;
transmitting, by the transmitting apparatus, the abstract data to a receiving apparatus of the data transmission system;
synthesizing, by the receiving apparatus, a synthesized voice data or a synthesized video data from the abstract data according to a second AI model; and
playing, by the receiving apparatus, the synthesized voice data or the synthesized video data.

2. The data transmission method of claim 1, wherein the information of the abstract data comprises media description, words, phrases, and emotional information in the voice data or the video data.

3. The data transmission method of claim 1, wherein the first AI model comprises at least one of a hidden Markov model (HMM) model and a neural network model.

4. The data transmission method of claim 1, wherein the second AI model comprises a text-to-speech (TTS) model.

5. The data transmission method of claim 1, wherein voice print information is stored in the receiving apparatus, and the data transmission method further comprise:
synthesizing, by the receiving apparatus, the synthesized voice data or the synthesized video data according to the abstract data and the voice print information.

6. The data transmission method of claim 1, wherein the information of the abstract data further comprises image information in an event that the abstract data is generated based on the video data.

7. A data transmission system, comprising:
a transmitting apparatus;
a network node; and
a receiving apparatus, wirelessly communicating with the transmitting device through the network node,
wherein the transmitting device generates a voice data for a voice call or a video data for a video call, transforms the voice data or the video data into an abstract data according to a first artificial intelligence (AI) model, wherein the abstract data comprises information related to the voice data or the video data, and a size of the abstract data is smaller than a size of the voice data or the video data, and transmits the abstract data to the receiving apparatus, and
wherein the receiving device synthesizes a synthesized voice data or a synthesized video data from the abstract data according to a second AI model, and plays the synthesized voice data or the synthesized video data.

8. The data transmission system of claim 7, wherein the information of the abstract data comprises media description, words, phrases, and emotional information in the voice data or the video data.

9. The data transmission system of claim 7, wherein the first AI model comprises at least one of a hidden Markov model (HMM) model and a neural network model.

10. The data transmission system of claim 7, wherein the second AI model comprises a text-to-speech (TTS) model.

11. The data transmission system of claim 7, wherein voice print information is stored in the receiving apparatus, and the data transmission method further comprises:
synthesizing, by the receiving apparatus, the synthesized voice data or the synthesized video data according to the abstract data and the voice print information.

12. The data transmission system of claim 7, wherein the information of the abstract data further comprises image information in an event that the abstract data is generated based on the video data.

13. A data transmission method, comprising:
performing, by a processor of a receiving apparatus, a voice call or a video call with a transmitting device;
receiving, by the processor, an abstract data from the transmitting apparatus, wherein the abstract data comprises information related to a voice data for the voice call or a video data for the video call, and a size of the abstract data is smaller than a size of the voice data or the video data;
synthesizing, by the processor, a synthesized voice data or a synthesized video data from the abstract data according to an artificial intelligence (AI) model; and
playing, by the processor, the synthesized voice data or the synthesized video data.

14. The data transmission method of claim 13, wherein the information of the abstract data comprises media description, words, phrases, and emotional information in the voice data or the video data, and wherein the information of the abstract data further comprises image information in an event that the abstract data is generated based on the video data.

15. The data transmission method of claim 13, wherein the AI model comprises a text-to-speech (TTS) model.

16. The data transmission method of claim 13, wherein voice print information is stored in the receiving apparatus, and the data transmission method further comprises:
synthesizing, by the processor, the synthesized voice data or the synthesized video data according to the abstract data and the voice print information.

17. An apparatus, comprising:
a transceiver which, during operation, wirelessly communicates with a transmitting apparatus through a network node; and
a processor communicatively coupled to the transceiver such that, during operation, the processor performs operations comprising:
performing a voice call or a video call with the transmitting device;
receiving, via the transceiver, an abstract data from the transmitting apparatus, wherein the abstract data comprises information related to a voice data for the voice call or a video data for the video call, and a size of the abstract data is smaller than a size of the voice data or the video data;
synthesizing a synthesized voice data or a synthesized video data from the abstract data according to an artificial intelligence (AI) model; and
playing the synthesized voice data or the synthesized video data.

18. The apparatus of claim 17, wherein the information of the abstract data comprises media description, words, phrases, and emotional information in the voice data or the video data, and wherein the information of the abstract data further comprises image information in an event that the abstract data is generated based on the video data.

19. The apparatus of claim 17, wherein the AI model comprises a text-to-speech (TTS) model.

20. The apparatus of claim 17, wherein voice print information is stored in the apparatus, and the processor further performs operations comprising:
synthesizing the synthesized voice data or the synthesized video data according to the abstract data and the voice print information.
